(19) United States
(12) Patent Application Publication
(10) Pub. No.: US 2006/0233001 A1
(43) Pub. Date: Oct. 19, 2006

(54) Integrated power supply module for filter

(76) Inventor: Shao Pai Chen, Taipei (TW)

Correspondence Address: BACON & THOMAS, PLLC, 625 SLATERS LANE, FOURTH FLOOR, ALEXANDRIA, VA, 22314, US

(21) Appl. No.: 11/105,425

(22) Filed: Apr. 14, 2005

(51) Int. Cl. H02M 1/00

(52) U.S. Cl. 363/146

(57) ABSTRACT

The present invention is a socket of card reader (I) for memory card with connecting terminals following specification of USB, which is a socket of card reader utilizing 4 pin USB (Universal Serial Bus) architecture for reading flash memory card with USB-compatible specification. The said socket of card reader is composed of a housing, a base, and 4 connecting terminals. Therefore, in comparison to the existing card reader that contains numerous connecting terminals, the present invention is apt to be implanted into related informational products. Besides, as the circuit architecture

### BACKGROUND OF THE INVENTION

1) Field of the Invention

The present invention is a high frequency filter for communication, in which a power supply module and interconnect are integrated inside the filter such that the filter can carry multiple cores and power supply module, through which the remote device connected through network connection is supplied signal as well as power, and thus excludes the need of installing power cord additionally.

2) Description of the Prior Art

Even now, the core for filter is still fabricated manually, in other words, the core is fixed onto the base board through manual welding, layer by layer. As a base board typically is welded multiple cores in an layer-based manner, significant man power and time are thus wasted. Besides, the connection to any one of the cores is not well welded or is disconnected, the yield of the whole filters is decreased. Therefore, the fabrication of core for filter influences the unit price of filter and the contention in market.

The present inventor has dived into the integrally structural design of filter, which includes integrating multiple cores into a single connecting module to enhance the welding operation during composition and thus increase the yield of productions, as shown in “Integrated structure of core for filter”—a patent granted by Taiwan patent office with filing number 093211204.

As the peripherals integrally connected through connecting port are increasing, the core modules carried by filter are getting more complicate. Lately, the manufacturers had developed a technology to deliver power to remote device through network cable with specification of RJ-45, as disclosed in the site of http://www.powerdsine.com/Solutions/WirelessLAN.asp. The present inventor integrates this function into a filter by utilizing a base board to allocate multiple cores, and installing power supply module as well as interconnect on the base board, in order to supply the demanded power to the peripherals connected to connecting port, and thus to meet the requirement of embedded-related manufacturers.

### SUMMARY OF THE INVENTION

The primary purpose of integrated power supply module for filter according the present invention is to provide a filter that utilizes a base board to allocate module component and interconnect for power supply, thus to supply power to remote device. Also, the present invention utilizes structural design of modualized core and base board to integrate multiple layers of core module into one, and thus to meet the requirement of embedded-related manufacturers for product size and interconnect allocation.

Therefore, the filter according to the present invention not only integrates circuit layout for power supply, but installs multiple core modules as well, the size of whole filter is thus significantly decreased, which has fully satisfied the necessary conditions of patent application. The detailed descriptions as well as the technical contents of the invention shall be given with the accompanying drawings hereunder.

### BRIEF DESCRIPTION OF THE DRAWINGS

FIG. 1 shows an exploded elevational view according to the present invention.

FIG. 2 shows a sectional view according to the present invention.

FIG. 3 shows a sectional view of allocating core modules according to the present invention.

FIG. 4 shows a sectional view of allocating core module in another embodiment according to the present invention.

FIG. 5 shows a schematic of power supply module according to the present invention.

FIG. 6 shows an embodiment of installing power supply module on the filter according to the present invention.

FIG. 7 shows another embodiment of installing power supply module on the filter according to the present invention.

FIG. 8 shows the remote devices to be connected by network hub.

### DETAILED DESCRIPTION OF THE PREFERRED EMBODIMENTS

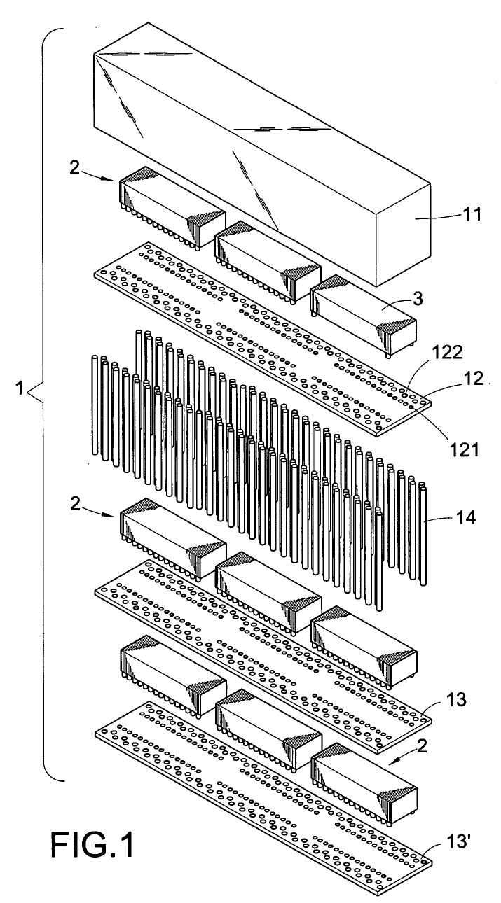

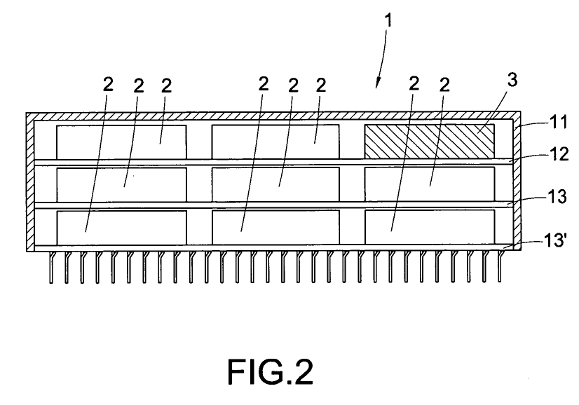

Referring to FIGS. 1 and 2, which show that the filter 1 according to the present invention at least includes a case 11, an upper base board 12, a lower base board 13, a bottom base board 13′, a power supply module 3, multiple connecting terminals 14, and core modules 2. In the said filter 1, eight core modules 2 are separately installed through the vias 121, 131, 131′ of the upper, lower base board 12, 13 and the bottom base board 13′, which are integrated in layer-based manner. The said upper, lower base board 12, 13 and the bottom base board 13′ are base board for printed circuit, on which electronics components and printed circuit are placed and routed. As the connecting terminals 14 are installed passing through vias 122, 132, 132′, the upper, lower base board 12, 13 and the bottom base board 13′ are connected and formed to be put into case 11 for packaging.

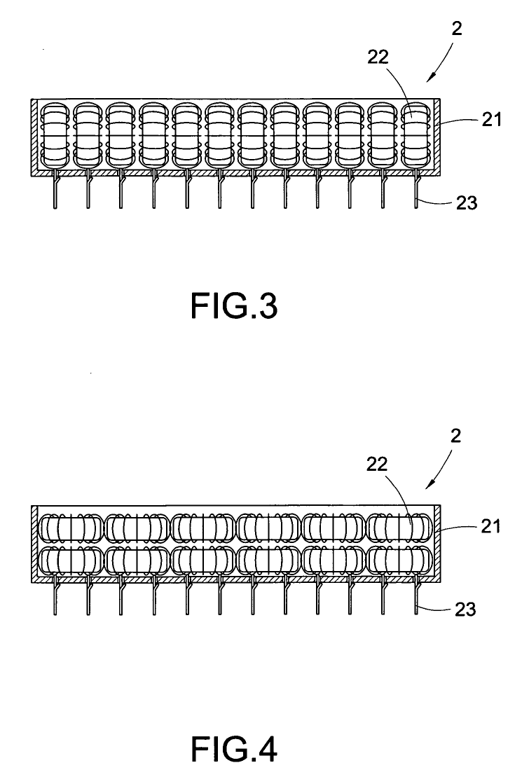

Further referring to FIG. 3, where the core module described above is integrated from multiple cores 22. The said cores 22 are vertically installed inside the base 21, and below the base 21 multiple terminals 23 are extended in order to be welded on the upper, lower base board, and the bottom base board 12, 13, 13′.

Moreover, referring to FIG. 4, which shows another structural design of cores. The base 21 of core module 2 allows multiple horizontally installed cores 22 while the terminals 23 follow the same specification as FIG. 3 does.

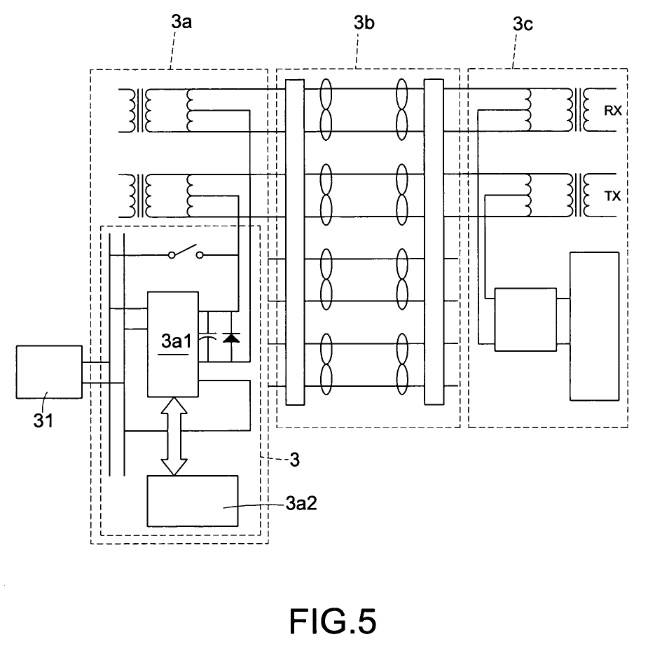

Further, referring to FIG. 5, which shows the embodied schematic of power supply module according to the present invention, where the power supply module 3 at least includes a power safety supply module 3a1 and a microprocessor 3a2, which are both installed inside the host side of Switch/HUB 3a. Although the power safety supply module 3a1 in this embodiment have 8 sets of connecting port, power safety supply module with 4 sets or 12 sets of connecting port can be embodied according to the present invention.

After power supply side 31 deliver power to the host side of Switch/HUB 3a, the power is regulated by way of the operation of power safety supply module 3a1 and a microprocessor 3a2 in the power supply module 3. The regulated power is output to remote power terminal manage module 3c through connecting module 3b (e.g., RJ-45 cable). The power supply between host side and remote side is thus completed, and accordingly, both signal and power are supplied to the remote device.

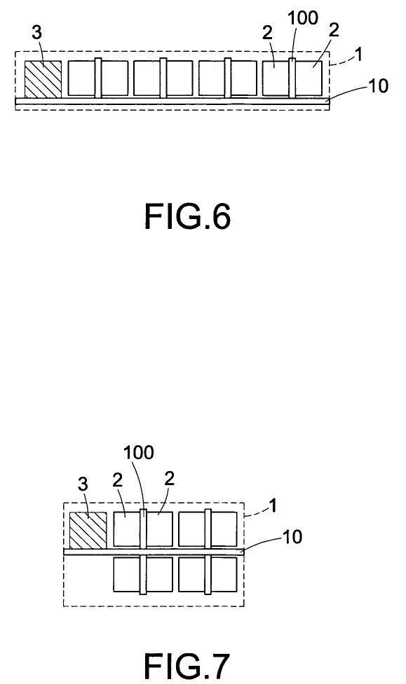

Further, referring to FIG. 6, which shows an embodiment of installing power supply module on the filter according to the present invention. The filter 1 as shown can be placed with eight core modules 2 and one power supply module 3. The said filter 1 primarily provides a base board 10, vertically installed base boards 100 are further provided on the base board 10, core modules 2 are respectively installed at two sides of each vertical base board 100, which forms a unit. As four vertical base boards 100 are installed on base board 10, thus eight core modules 2 are included in a filter 1. Besides, a component of power supply module 3 is installed at one end of base board 10. On the other hand, referring to FIG. 7, which shows another embodiment of installing power supply module on the filter according to the present invention. The filter 1 in FIG. 7 is generally the same as that in FIG. 6. The major difference is that in FIG. 7 two vertical base boards 100 are respectively installed at upper and lower side of base board 10, thus provides eight core modules in filter 1. Yet again, component of power supply module 3 is installed at one end of base board 10.

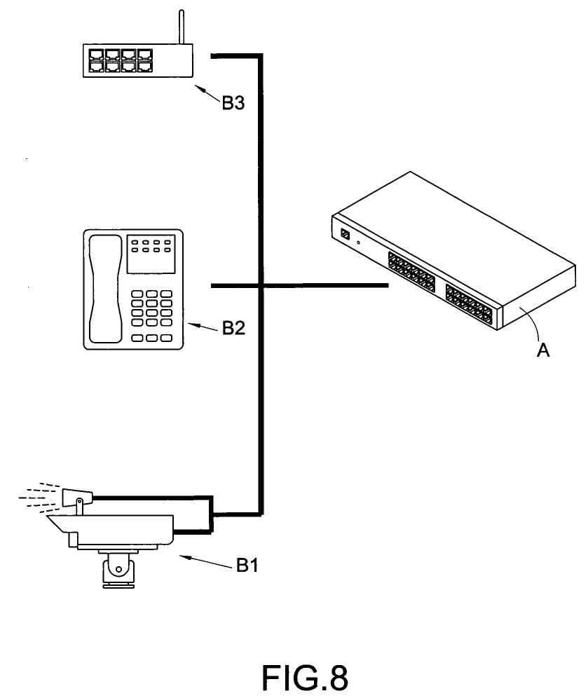

With the fast advance of network, the sorts of related peripheral are getting richer. As shown in FIG. 8, the remote devices can be connected through network hub A with power supply include wireless base station B3, IP phone B2, and monitor B1, etc. As remote equipments need power for driving, and owing to the eagerness for integration, the present invention not only integrates core module 2 and power supply module 3, but also avoids the need of additionally providing power cord for remote devices by direct delivering power to remote device through RJ-45 cable. Consequently, the cost of installing power cord is saved, and the size as well as failure rate of whole filter is significantly decreased.

1. An integrated power supply module for filter, at least includes:
a case, which is provided for enveloping the components of whole filter;
an upper base board, which is a base for printed circuit board, and vias are provided at the base board for welding connecting terminals, core modules, and power supply modules;
a lower base board, which is a base for printed circuit board, and vias are provided at the base board for welding connecting terminals and core modules;
a bottom base board, which is a base for printed circuit board, and vias are provided at the base board for welding connecting terminals and core modules;
a power supply module, which is provided for managing operations of input power and supplying power to connected remote devices;
multiple connecting terminals, which are provided for connecting metal conductors of the upper, lower, and bottom base boards; and
core module, which is a base with multiple cores installed inside, where both ends of coil of the said core are penetrated through the bottom of base, and terminals are extended to be welded to base boards;
such that, utilizing the structural design of stacked base boards and multiple core modules, two or more than two layers of core modules are integrated into a filter, and a power supply management module is provided on the base boards to supply power to remotely connected devices.

2. An integrated power supply module for filter in accordance with claim 1, wherein at least one core module can be welded at one side of the upper, lower, and bottom base boards.

3. An integrated power supply module for filter in accordance with claim 1, wherein the power supply module at least includes a power safety supply module and a microprocessor chip.

4. An integrated power supply module for filter, at least includes:
a case, which is provided for enveloping the components of whole filter;
an upper base board, which is a base for printed circuit board, and the said base board is provided for welding vertically installing base boards;
a vertically installed base boards, where vias are provided for welding core modules;
a power supply module, which is provided for managing operations of input power and supplying power to connected remote devices;
multiple connecting terminals, which are provided for connecting metal conductors of base boards; and
core module, which is a base with multiple cores installed inside, where both ends of coil of the said core are penetrated through the bottom of base, and terminals are extended for welding base boards.

5. An integrated power supply module for filter in accordance with claim 4 wherein at least one vertically installed base boards can be welded at one side or both sides of base boards
